(19) United States
(12) Patent Application Publication
(10) Pub. No.: US 2023/0088174 A1
(43) Pub. Date: Mar. 23, 2023

(54) SMART WATCH WITH CONTROL DIAL

(71) Applicant: OXTI CORPORATION, New Taipei City (TW)

(72) Inventor: Chih-Feng Ho, New Taipei City (TW)

(21) Appl. No.: 17/481,320

(22) Filed: Sep. 22, 2021

(51) Int. Cl. G04G 21/08; G04G 9/00

(52) U.S. Cl. CPC G04G 21/08; G04G 9/007

(57) ABSTRACT

The smart watch with a control dial includes a watch body having a display on a top side and a control circuit inside the watch body, and a control dial electrically connected to the control circuit. The control dial has a portion of its circumference exposed from a lateral side of the watch body, and, when the control dial is turned, the control circuit detects the movement of the control dial and adjusts correspondingly the content shown on the display. The physical movement provided by the control dial effectively prevents the problem of operating the touch screen of the smart watch when the touch screen is stained.

### BACKGROUND OF THE INVENTION

### (a) Technical Field of the Invention

The present invention is generally related to wearable devices, and more particular to smart watches.

### (b) Description of the Prior Art

Generally, a smart watch includes a watch body and a watch band through which the watch body is fixed a user's wrist. The smart watch often provides a touch screen as the user interface as taught, for example, by R.O.C. Taiwan Patent No. 1668607.

The touch screen detects the user's finger action through sensors. The sensitivity of the sensors, and therefore the operability of the touch screen, is compromised by grease, sweat, dust, etc. on the touch screen.

### SUMMARY OF THE INVENTION

To overcome the foregoing shortcoming of the conventional smart watch, the present invention provides a smart watch with a control dial.

The smart watch with a control dial includes:

a watch body having a display on a top side of the watch body and a control circuit inside the watch body; and

a control dial electrically connected to the control circuit, where the control dial has a portion of its circumference exposed from a lateral side of the watch body, and, when the control dial is turned, the control circuit detects the movement of the control dial and adjusts correspondingly the content shown on the display.

Preferably, the control dial has a serrated circumference with a number of teeth to facilitate the turning of the control dial.

By having a control dial and exposing part of the control dial from a side of the watch body, a user may twist the control dial to interact with a graphic user interface shown on the display. The control circuit detects the rotational movement of the control dial and adjusts the graphic user interface correspondingly on the display. The physical movement provided by the control dial effectively prevents the problem of operating the touch screen of the smart watch when the touch screen is stained. The control dial may be exposed from the left or right lateral side of the watch body so that it is convenient for either a left-handed or right-handed user.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a top view diagram showing a smart watch according to an embodiment of the present invention where a control dial is exposed from a lateral side of the watch body.

FIG. 2 is a top view diagram showing a smart watch according to another embodiment of the present invention where the control dial is exposed from another lateral side of the watch body.

FIG. 3 is a schematic diagram showing the interaction between components of the smart watch of FIG. 1 or FIG. 2.

FIG. 4 is a top view diagram showing an operation scenario of the smart watch of FIG. 1.

FIG. 5 is a top view diagram showing an operation scenario of the smart watch of FIG. 2.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

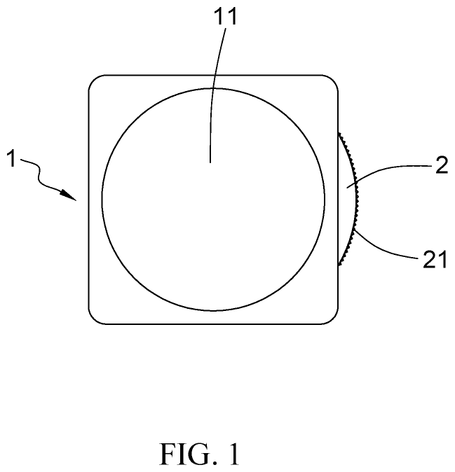

As shown in FIG. 1, a smart watch according to an embodiment of the present invention includes:

a watch body 1 having a display 11 on a top side of the watch body and a control circuit 12 inside the watch body; and

a control dial 2 electrically connected to the control circuit, where the control dial 2 has a portion of its circumference exposed from a first lateral side of the watch body 1, and, when the control dial 2 is turned, the control circuit 12 detects the movement of the control dial 2 and adjusts correspondingly content shown on the display 11.

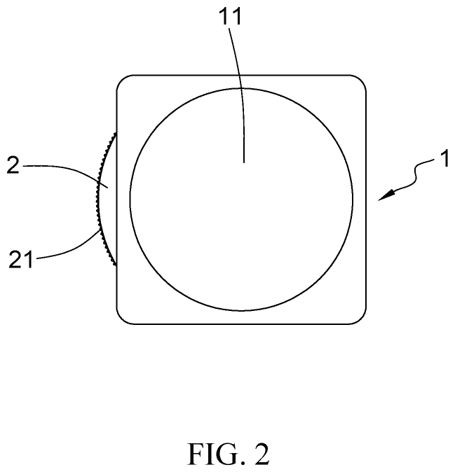

As shown in FIG. 2, the control dial 2 has a portion of its circumference exposed from a second lateral side of the watch body 1 opposite to the first lateral side.

Preferably, the control dial 2 has a serrated circumference with a number of teeth 21 to facilitate the turning of the control dial 2.

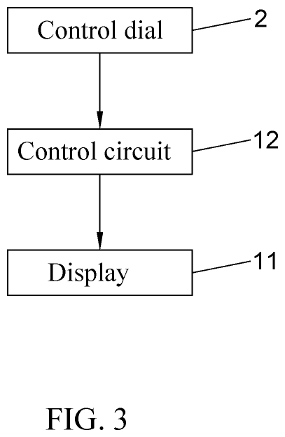

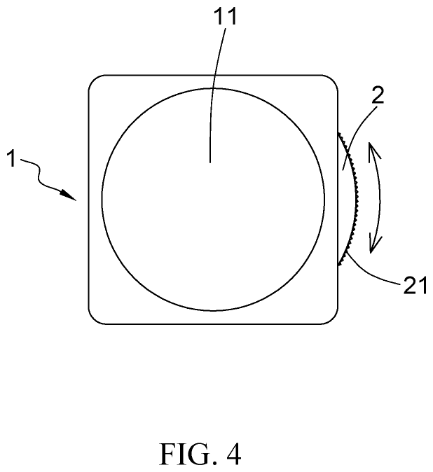

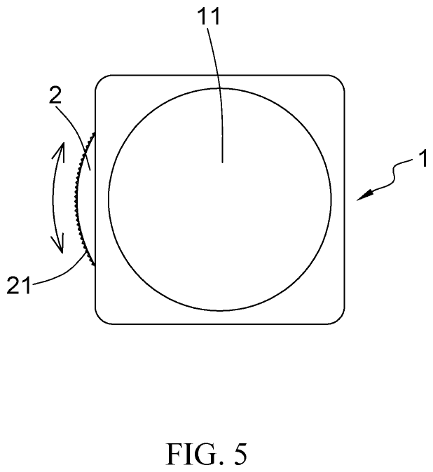

By having a control dial 2 and exposing part of the control dial 2 from a side of the watch body 1, a user may twist the control dial 2 to interact with a graphic user interface shown on the display 11. The control circuit 12 detects the rotational movement of the control dial 2 and adjusts the graphic user interface correspondingly on the display 11, as shown in FIG. 3. The physical movement provided by the control dial 2 effectively prevents the problem of operating the touch screen of the smart watch when the touch screen is stained. The control dial 2 may be exposed from the left or right lateral side of the watch body 1 so that it is convenient for either a left-handed or right-handed user, as shown in FIGS. 4 and 5.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

I claim:

1. A smart watch, comprising:
a watch body having a display on a top side of the watch body and a control circuit inside the watch body; and
a control dial electrically connected to the control circuit, and having a portion of a circumference exposed from the watch body;
wherein, when the control dial is turned by the exposed portion, the control circuit detects the rotational movement of the control dial and adjusts correspondingly a display content shown on the display.

2. The smart watch according to claim 1, wherein the portion of the circumference of the control dial is serrated with a plurality of teeth.

3. The smart watch according to claim 1, wherein the control dial is exposed from a first lateral side of the watch body.

4. The smart watch according to claim 1, wherein the control dial is exposed from a second lateral side of the watch body.
